(19) United States
(12) Patent Application Publication
(10) Pub. No.: US 2002/0099739 A1
(43) Pub. Date: Jul. 25, 2002

(54) Transformation and processing of Web form documents and data for small footprint devices

(76) Inventor: Herman Fischer, Woodland Hills, CA (US)

Correspondence Address: David A. Hall, Heller Ehrman White & McAuliffe LLP, 7th Floor, 4350 La Jolla Village Drive, San Diego, CA, 92122-1246, US

(21) Appl. No.: 10/038,082

(22) Filed: Jan. 2, 2002

Related U.S. Application Data
(60) Provisional application No. 60/259,471, filed on Jan. 3, 2001.

(51) Int. Cl. G06F 15/00

(52) U.S. Cl. 707/515; 707/513

(57) ABSTRACT

A content transformer transforms computer network content, such as a Web page, so that the content can be displayed on any type of user device that is communicatively coupled to a computer network. The content transformer functions as a surrogate server between any network content server and the user device, so that all content that is received by the user device first passes through the content transformer. The content transformer transforms Web form documents that are served by the content server so the documents are in a format that is suited for the user device. The content transformer divides a form document into a series of subdocuments that are optimized for the display screen and memory constraints of the user device. The content transformer also stores any user-provided data from the form document in a data storage location that is local to the content transformer. The content transformer provides the data to the content server when it is determined that the user has requested submittal of the data to the content server.

### REFERENCE TO RELATED APPLICATIONS

This application claims the benefit of priority from U.S. Provisional Application Ser. No. 60/259,471, entitled “Transformation of Web Form Documents and Data for Small Footprint Devices,” filed Jan. 3, 2001, which is incorporated herein by reference.

### BACKGROUND OF THE INVENTION

1. Field of the Invention

The present invention is related to the Internet, and more particularly, to the processing of Web form documents for display on a variety of user devices.

2. Description of the Related Art

The Internet and World Wide Web (“Web”), comprised of a vast array of international computer networks, provides online service users with considerable information resources and other content. Such content includes Web pages, which are documents that are written in a markup language, such as the HyperText Markup Language (HTML), and served to local computer device by a Web server. Some Web pages are form Web pages, which are Web pages that are used to gather information from a user. One example of the use of a form Web page is where a user purchases a product through the Internet. The user is generally required to provide personal information in connection with the purchase, such as name, address, credit card number, etc.

The form Web page typically includes one or more data entry fields. When the form Web page is displayed on the display screen of the local computer device, the user can enter information, such as alphanumeric data, into the data entry fields on the form page. Sometimes a Web form page includes a large quantity of data entry fields so that several consecutive pages are required to display all of the fields. In such a case, the form Web page may include user interfaces by which the user can cycle through the multiple form documents in a series. For example, a form document could include a “next” button or a “back” button for cycling forward or backward through a series of form documents.

When the user selects such a “next” or “back” button, the user's computer device transmits a request to the Web server that served the Web form document to obtain the corresponding document in the series. The request includes a copy of the data that the user had provided in the data entry fields of the Web form page. The Web server then stores the data and transmits the requested Web form page to the user device. As the user cycles through the Web form pages, the Web server collects the user provided data for eventual processing. This method works fine for conventional computer devices that are attached to the Internet, where the computer device can establish a direct logical link to the Web server and exchange data and Web form documents without interruption.

However, this process may present problems in situations where an intermediate device, such as a server, is located in the communication path between the Web server that served the Web form document and the local computer device. The intermediate device can interrupt communication between the user device and the Web server and thereby prevent the free exchange of Web form documents and the associated data. In such a case, it may be desirable to perform some intermediate processing of Web form documents and the associated data so that the document and data is exchanged without any problems.

### SUMMARY OF THE INVENTION

The invention relates to a system and method for processing Web form documents and associated data. A content transformer functions as surrogate server between a network content server and the user device, so that all content that is received by the user device first passes through the content transformer. In accordance with the transformation of content, the content transformer transforms Web form documents that are served by the content server so that the documents are in a format that is suited for the user device. The content transformer divides a form document into a series of subdocuments that are optimized for the display screen and memory constraints of the user device. The content transformer also stores any user-provided data from the form document in a data storage location that is local to the content transformer. The content transformer provides the data to the content server when it is determined that the user has requested submittal of the data to the content server.

Other features and advantages of the present invention should be apparent from the following description of the preferred embodiment, which illustrates, by way of example, the principles of the invention.

### BRIEF DESCRIPTION OF THE DRAWINGS

FIG. 1 is an architectural representation of a computer network system that implements the content transformation described herein.

FIG. 2 is a representation of Web content comprised of an exemplary Web form document.

FIG. 3 is a schematic representation of a communication path that the content follows in the course of being transmitted from a content server to a user device.

FIG. 4 is a flow diagram that illustrates the general operations involved in the transfer and transformation of content from the content server to the user device.

FIG. 5 is an illustration of a Web form document and a set of associated subdocuments that result from a transformation of the Web form document.

FIGS. 6A and 6B show a flow diagram that describes the processing steps performed in transformation of a Web form document.

FIG. 7 is a block diagram of a computer device that is a node of the computer network of FIG. 1.

### DETAILED DESCRIPTION

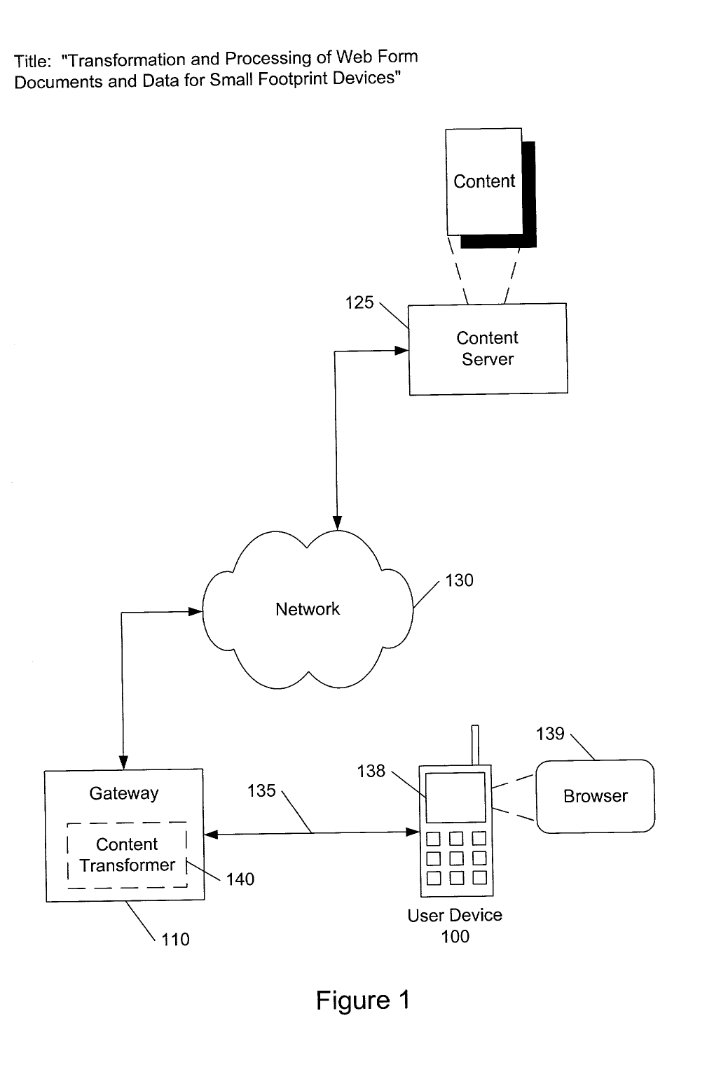

FIG. 1 shows a computer network system comprised of a user device 100, a network gateway device 110, and a Web content server 125, which are nodes of a computer network. The network gateway device 110 and the content server 125 are communicatively linked via a computer network 130, such as the Internet. As used herein, the term “Internet” refers to a collection of interconnected (public and/or private) networks that are linked together by a set of standard protocols (such as TCP/IP and HTTP) to form a global, distributed network. While this term is intended to refer to what is now commonly known as the Internet, it is also intended to encompass variations which may be made in the future, including changes and additions to existing standard protocols. FIG. 1 shows only a single user device 100, a single server 125, and a single gateway device 110, although the computer network system could include a plurality of such devices.

As described in detail below, a content transformer 140 is configured to transform network content so that the content can be displayed on any type of user device 100. If the network 130 comprises the Internet, the user device 100 can advantageously browse any Web site on the Internet by way of the content transformer 140, which transforms Web content into a format suitable for the user device 100. The content transformer 140 preferably acts as a pass-through or surrogate server between any network content server and the user device 100, so that all content that is received by the user device 100 first passes through the content transformer 140. The content transformer 140 can reside anywhere in the communication path between the content server 125 and the user device 100, although the content transformer 140 is described herein as residing at the gateway device 110.

In accordance with the transformation of content, the content transformer 140 transforms Web form documents that are served by the content server 125 so that the documents are in a format that is suited for the user device 100. A Web form document is a Web page that that is used to gather data from a user. The content transformer 140 divides a form document into two or more subdocuments that are each sized to fit within the display screen and memory constraints of the user device 100. The content transformer 140 also stores any user-provided data from the form document in a data storage location that is local to the content transformer 140. The content transformer 140 provides the data to the content server when it is determined that the user has requested submittal of the data to the content server 125.

With reference to FIG. 1, the user device 100 comprises any device that is configured to interact with the network 130. In one embodiment, the user device 100 comprises a mobile, hand-held device having an antenna that interacts with the network 130 through a wireless communication link 135 with the gateway device 110. The hand-held user device 100 is preferably of a size such that a human can hold and transport the user device 100 in his or her hand. Such devices include mobile phones and personal digital assistants and typically include a display screen having a size that is smaller than the display screens that are typically associated with personal computers. For example, a rectangular display screen 138 for the user device 100 may have a width and height that are both less than 5 inches.

A browser 139 preferably resides in the memory of the user device 100. The browser 139 is a software application that is used to request and display content from the network 130, such as World Wide Web pages. In the case of the user device 100 being a hand-held device, the browser 139 is preferably a microbrowser comprised of an Internet browser with a small file size that can accommodate the memory constraints of the user device 100 and the bandwidth constraints of the wireless communication link 135.

The gateway device 110 comprises a device, such as a computer, that functions as a communication entryway/exitway to/from the network 130 for the user device 100. The gateway device 110 provides the user device 100 with access to the network 130 such that any communication between the network 130 and the user device 100 travels through the gateway device 110. As mentioned, the user device 100 preferably communicates with the gateway device 110 via a wireless communication link 135. In this regard, the gateway device 110 preferably converts content received from the network 130 into a format suitable for transport over the wireless communication link 135.

The content server 125 comprises a computer system that stores content and serves the content over the network 130, such as using the standard protocols of the World Wide Web. The content server 125 is representative of any source of content available to the user device 100 via the network 130. The content server 125 is generally intended to encompass both the hardware and software server components that serve the content over the network 130. The content server 125 is not limited to comprising a single computer device, as the content server 125 could, for example, include multiple computer devices that are appropriately linked together.

As used herein, the term “content” refers to any type of electronic data that may be served by the content server 125 and transported over the network 130, including Web pages. The term “native format” is used herein to refer to the format in which the content is stored by the content server 125. The user device 100 may be unable to interpret and use content that is in a native format due, for example, to hardware capability restrictions of the user device 100 or software incompatibilities between the user device 100 and the content server 125. The term “user device format” is used to refer to content in a format that is suitable for interpretation and use by the user device 100.

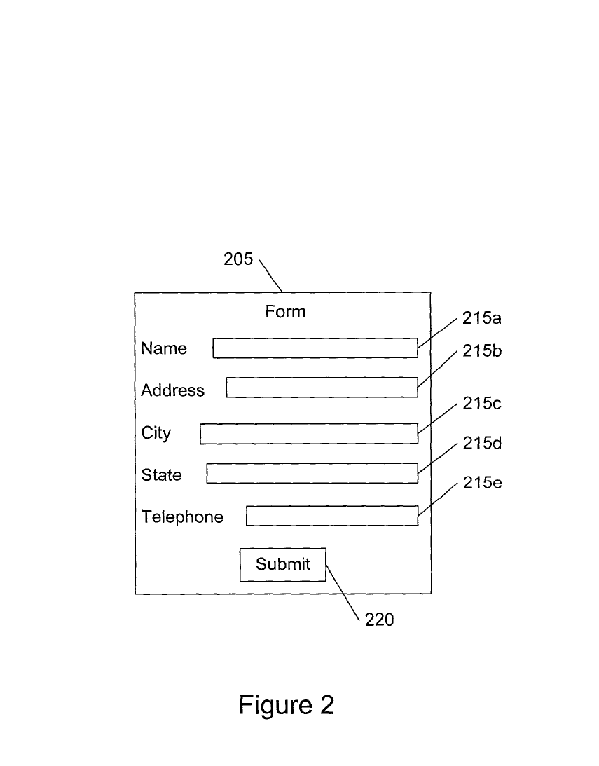

The content may comprise a Web page (also referred to herein as a Web document), which is comprised of a hyperlink document that is written in a descriptive markup language, such as, for example, the Hyper Text Markup Language (HTML) and that is available over the Internet. FIG. 2 shows a Web form document 205 as it would normally be displayed on a window of a browser application, such as “Internet Explorer” from Microsoft Corporation or “Navigator” from Netscape Communications Corporation, that is loaded on a computer device.

The Web form document 205 comprises a Web form document that is used to gather information from a user. The user provides the information into data entry fields on the form and then submits the information via the network 130 to a device (such as the content server 125). The Web form document 205a includes a plurality of data entry fields 215 for collecting data from the user (the data entry fields are referred to collectively using the reference numeral 215 and individually using the reference numeral 215 and a letter suffix). The data entry fields 215 comprise fields where a user may provide data using a data entry device. Each data entry field 215 preferably has an associated label that describes the data field.

In the illustrated embodiment, the data entry fields include a “Name” data entry field 215a, an “Address” data entry field 215b, a “City” data entry field 215c, a “State” data entry field 215d, and a “Telephone” data entry field 215e. It will be appreciated that the Web form document 205 could include any of a wide variety of data entry fields and labels for entering or selecting any of a wide variety of data. The form document 205 could also include other types of fields for selecting and providing data, such as a drop-down menu, or fields for checking boxes, pushing radio buttons, audio/response selections, or the like.

The Web form document 205 also includes a “Submit” button 225 that may be selected and activated by the user. When the “Submit” button 225 is activated, any data that is present in the data entry fields 215 is transmitted to the server that serves the page, as will be known to those skilled in the art.

As mentioned, the Web form document 205 may be written in a descriptive markup language, such as HTML. The HTML code for the Web form document 205 includes markup identifiers, or tags, that delimit the elements of the Web page. The tags may be used to identify a Web page as a form document and to delimit the data fields in the form. In HTML, the <FORM>tag can be used to identify a document as a form. Data fields within the form document are identified using the <INPUT>tag. The <INPUT>tag is combined with one or more attributes to identify the format of the data field. For example, the “TYPE=” attribute is used to identify the input method, such as to identify whether the data field is a text input (TYPE=TEXT), a radio button input (TYPE=RADIO), a checkbox input (TYPE=CHECKBOX), or any other type of input, such as a drop-down menu. The submit button 225 is identified in HTML using the TYPE=SUBMIT attribute, which produces a button that, when selected, submits the user-provided data to a server. It is appreciated that other tags, as well as other markup languages, can also be used to identify form documents and the corresponding elements.

With reference again to FIG. 1, the content transformer 140 is configured to transform content into a user device format that is suitable for interpretation and display on the user device 100. The content transformer 140 preferably transforms content according to a set of predefined rules, which may be defined generally or on a page-by-page and/or site-by-site basis, as described in more detail below. The content transformer 140 may comprise either the hardware or software components that perform the aforementioned content transformation, or both. In this regard, the content transformer 140 may comprise software that resides in the memory of the content server 125 and/or the gateway device 110. The content transformer 140 may also comprise a combination of software and hardware that is physically separate from the content server 125 and the gateway device 110.

Content Communication Path and General Transformation Process

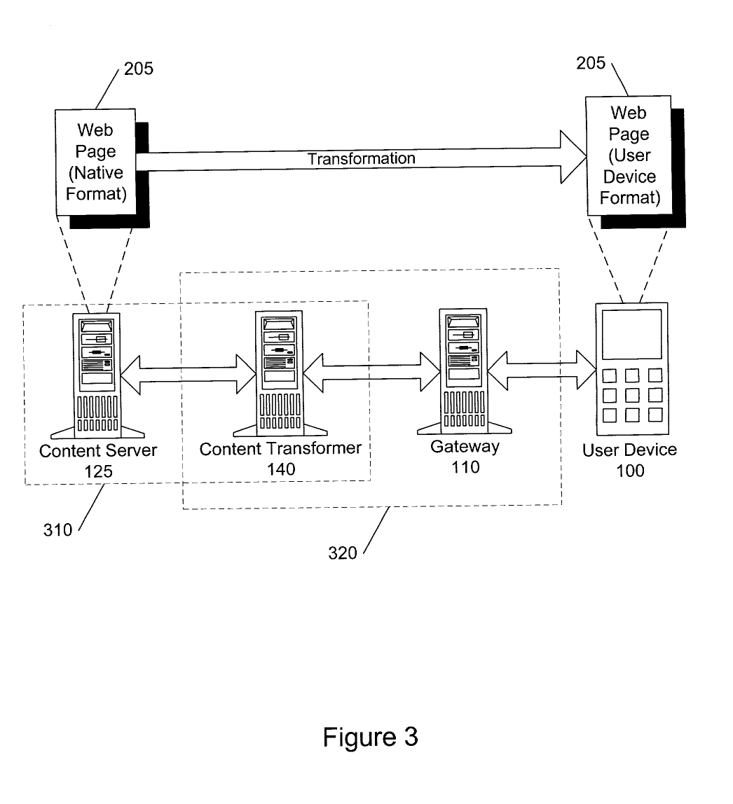

FIG. 3 schematically illustrates the communication path that content follows in the course of being transmitted from the content server 125 to the user device 100 according to one aspect of the invention. The content is described in the exemplary context of a Web form document 205 that is stored and served by the content server 125. The communication path of the Web form document 205 originates at the content server 125, where the Web form document 205 is stored in a native format. The native format of the Web form document 205 may comprise, for example, HTML code containing various HTML tags that define the Web form document 205.

The communication path of the Web form document 205 continues to the content transformer 140, where the Web form document 205 is transformed into a user device format. The transformation occurs wherever the content transformer 140 resides. The content transformer could reside at the content server 125 (as exhibited by the dashed box 310 in FIG. 3) or at the gateway device 110 (as exhibited by the dashed box 320 in FIG. 3). The content transformer 140 could also reside at a stand-alone site that communicates with the network 130. A separate instance of the content transformer 140 may also be located at each location, in which case the downstream (closest to content server 125) instance of the content transformer 140 would allow the upstream (closest to user device 100) instance of the content transformer 140 to retrieve respective rule sets for correct processing. This ensures that the content rules are correctly utilized in the transformation process. The content transformer 140 is described herein as residing at the gateway device 110.

From the gateway device 110, the communication path of the Web form document 205 continues to the user device 100. As a result of the transformations, the Web form document 205 is in a user device format when received by the user device 100. The user device 100 can then display the Web form document 205 on its display screen.

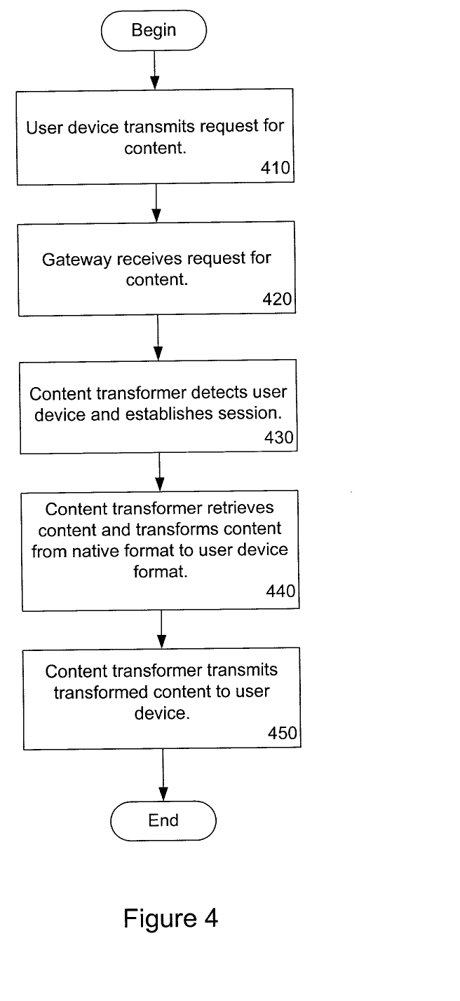

FIG. 4 is a flow chart that describes the general processes involved in the request, transfer, and transformation of content. In a first operation, represented by the flow diagram box numbered 410, the user device 100 transmits a request for content. The request includes a uniform resource locator (URL), which specifies the location of content on the network 130. In this example, the URL identifies the content server 125 as being the location of the content, which is described herein as a Web form document. The user device 100 can transmit the request, for example, by the user selecting a hyperlink on the display screen of the user device 100 or by the user manually entering a URL using alpha-numeric keys on the user device 100.

The gateway device 110 then receives the request for content from the user device 100, as represented by the flow diagram box numbered 420. The content transformer 140, which resides at the gateway device 110, detects the user device 100 and establishes a session for the user device 100. This is represented by the flow diagram box numbered 430.

In the next operation, the content transformer 140 retrieves the requested Web form document, which may be written in HTML, and transforms the Web form document from a native format into a user device format, as represented by the flow diagram box numbered 440. As mentioned, the content transformation occurs wherever the content transformer 140 resides, which in the current example is at the gateway device 110. The content transformer 140 transforms the content into a format that is optimized for display on the user device 100. The content transformer 140 preferably accesses a set of rules that govern the transformation and conducts a semantic and structural analysis of the content according to the processes described in co-pending U.S. patent application Ser. No. 09/886,299 entitled “ADAPTIVE PROFILE-BASED MOBILE DOCUMENT INTEGRATION,” which is incorporated herein by reference and is assigned to the assignee of this application.

During the content transformation process, the content transformer 140 determines the display screen capabilities of the user device and, if necessary, divides the Web form document into two or more subdocuments that are each sized to fit within the display screen and memory constraints of the user device 100. Preferably, the content transformer 140 splits the Web form document into a series of consecutive subdocuments with data fields that correspond to the data fields of the original Web form document. The subdocuments collectively include all of the data fields of the original Web form document.

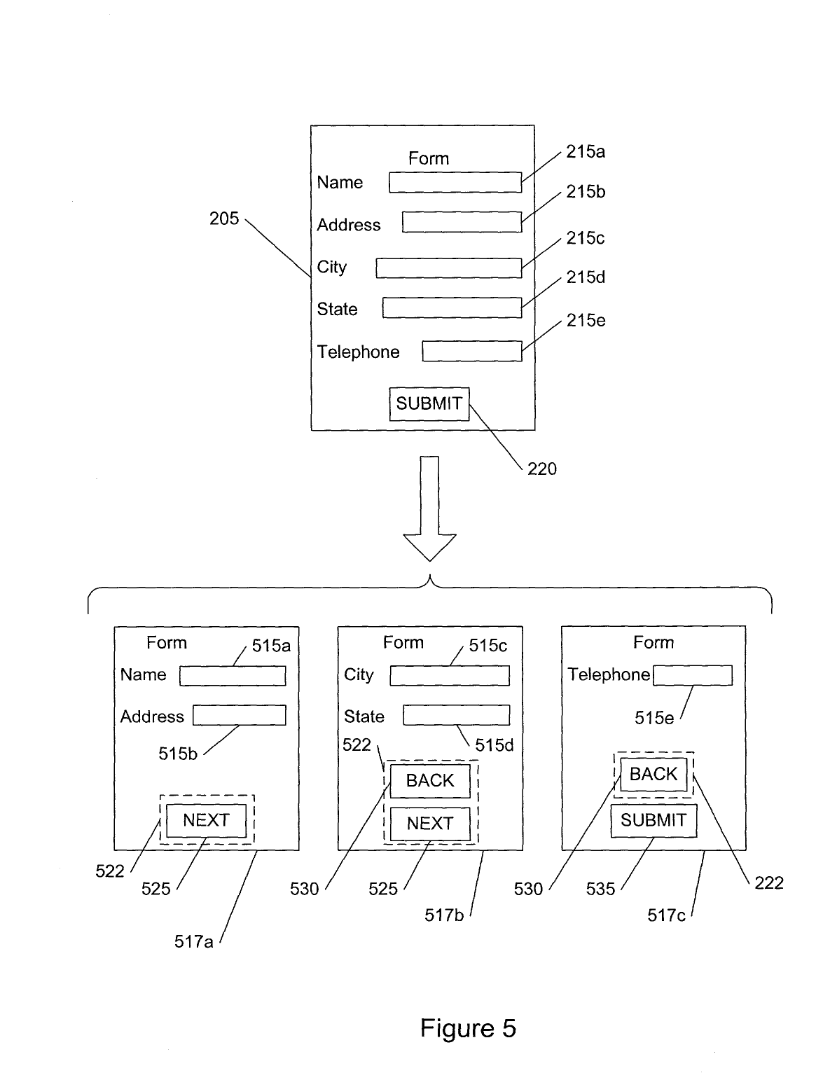

In an example shown in FIG. 5, the content transformer 140 splits the form document 205 into three consecutive subdocuments 517a, 517b, and 517c. The subdocuments 517 are each configured to fit within the display and memory capabilities of the user device 100. The subdocument 517a includes the “Name” data field 515a and the “Address” data field 515 b. The subdocument 517b includes the “City” data field 515c and the “State” data field 515d. The subdocument 517c includes the “Telephone” data field 515e. As mentioned, the form document 210 could be split into any number of subdocuments 517.

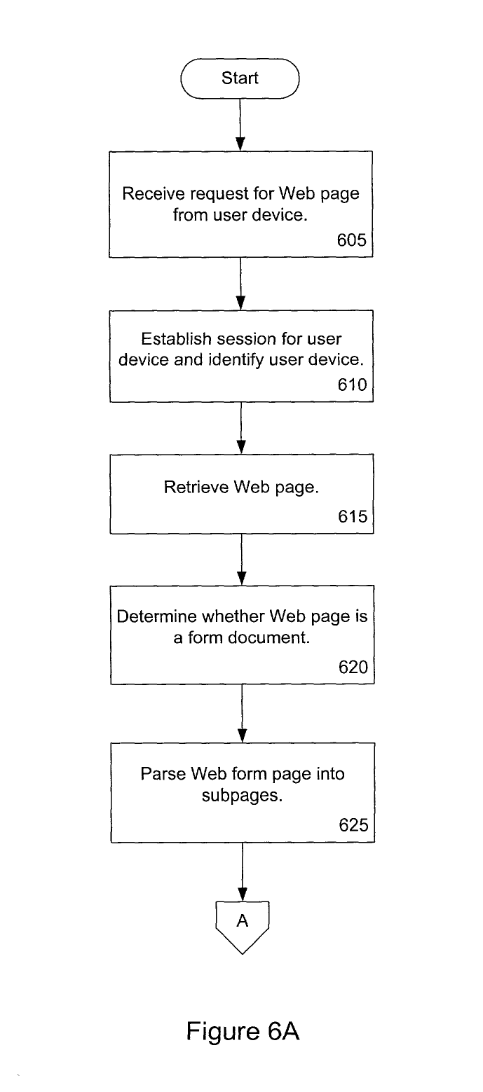

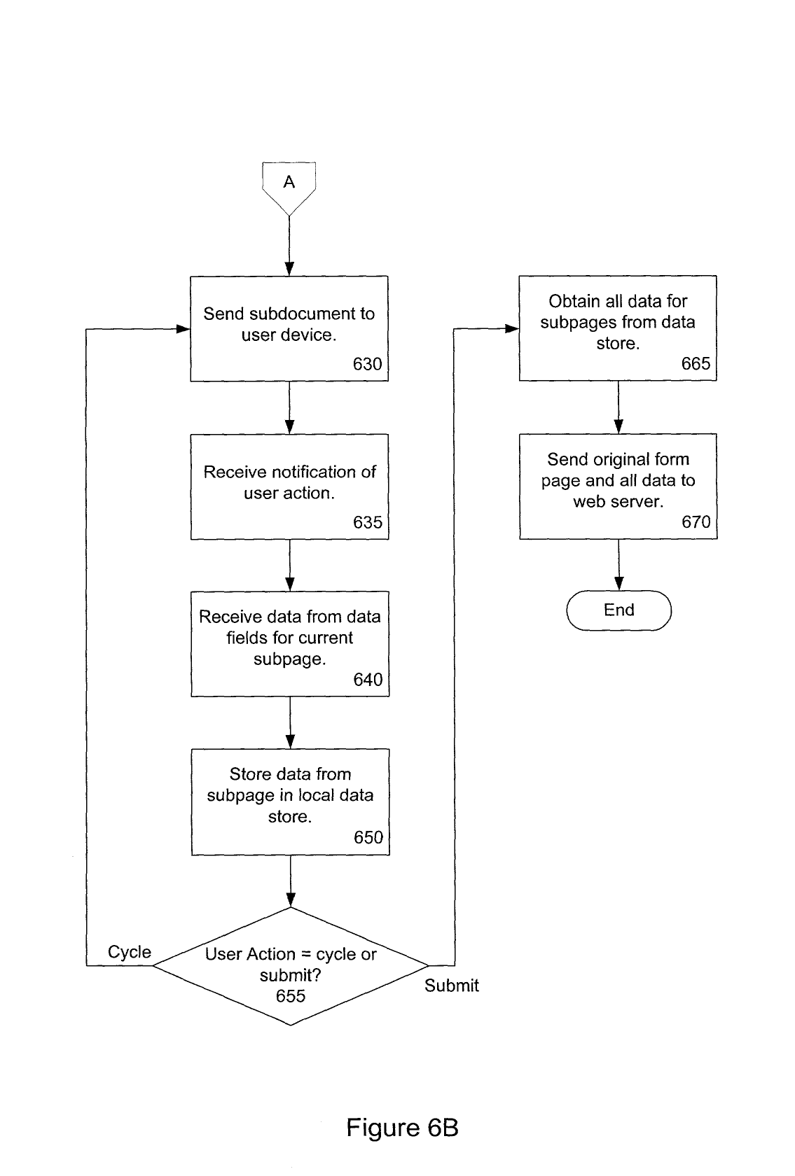

The subdocuments 517 preferably include cycle buttons 522 that allow the user to cycle through the subdocuments 517. The cycle buttons include a “next” button 525 and a “back” button 530. When the “next” button 525 is selected, the content transformer 140 transmits the next subdocument 517 in the series of subdocuments 517a, 517b, and 517c. When the “back” button is selected, the content transformer 140 transmits the previous consecutive subdocument in the series of subdocuments 517a, 517b, and 517c. For example, if the user is viewing the subdocument 517b, then the user can select the “next” button to access the subdocument 517c. Likewise, the user can select the “back” button to access the subdocument 517a. Preferably, the last subdocument 517c includes a “Submit” button by which the user can request that any data associated with the subdocuments 517 be transmitted to the Web server 125. This process is described in more detail below with respect to the flow diagram of FIG. 6A and FIG. 6B.

With reference again to FIG. 4, after transformation of the content, the content transformer 140 transmits the transformed content to the user device 100 for display. This is represented by the flow diagram box numbered 450. In the case of the content being a Web form document, the content is transformed into a series of subdocuments. The content transformer 140 preferably transmits the first subdocument in the series to the user device 100.

Processing of Form Documents

FIGS. 6A and 6B show a flow diagram that describes the operations performed by the content transformer 140 in processing a Web form document. In the first operation, represented by the flow diagram box numbered 605, the content transformer 140 (via the gateway device 110) receives a request from the user device 100 for content, which is described herein as being a Web document. The request typically includes a URL that specifies the location of the Web page on the network 130.

The content transformer 140 then establishes a session for the user device 100 and identifies the user device 100, as represented by the flow diagram box numbered 610. The content transformer 140 receives information regarding the user device 100, including information regarding the memory capacity, display screen size, and data transmission bandwidth of the user device 100.

In the next operation, represented by the flow diagram box numbered 615, the content transformer 140 retrieves the requested Web page in a well known manner. The content transformer 140 typically establishes a connection with a server device that serves the requested Web page and then receives a copy of the Web page over the network 130 from the server device.

In the next operation, represented by the flow diagram box numbered 620, the content transformer 140 examines the Web page to determine if the Web page is a form document. The content transformer 140 preferably searches for tags that would identify the Web page as a form document, such as the <FORM>tag in an HTML document. The content transformer 140 also determines whether a transformation of the Web page is necessary. The Web page need not be transformed if the native format is suitable for use by the user device 100, such as if it is determined that the Web page can be legibly displayed within the display screen of the user device 100 without dividing the Web page into subdocuments. The content transformer 140 preferably considers the size of the display screen and communication bandwidth, as well as the memory capacity of the user device 100 in determining whether a transformation is necessary. If a transformation is not necessary, then the process ends.

If the Web document is a Web form document that requires transformation, the process proceeds to the next operation (flow diagram box 625), where the content transformer 140 splits or parses the Web form document into a series of two or more subdocuments. For example, FIG. 2 shows the Web page 205 split into three subdocuments, 517a, 517b, and 517c. The subdocuments collectively contain all of the data entry fields from the original Web page. The subdocuments are sized to fit within the display screen, bandwidth, and memory capacity of the user device 100.

With reference to FIG. 6B, the content transformer 140 next transmits a subdocument to the user device 100, as illustrated by the flow diagram box numbered 630. The first subdocument in the series is the first to be transmitted to the user device 100 for display. For example, with reference to FIG. 2, the content transformer 140 transmits the first subdocument 517a to the user device. The user can then enter data into the corresponding data entry fields of the subdocument.

In the next operation, represented by the flow diagram box numbered 635, the content transformer 140 receives notification via a transmission from the user device 100 that the user has performed a user action comprised of either selecting a “cycle page” button (i.e., the “next” or “back” button) on a subdocument or selecting the “submit” button on a subdocument. The transmission includes the data that the user provided into the data entry fields of the current subdocument that is displayed on the user device 100. The content transformer 140 receives the data, as represented by the flow diagram box numbered 640. The content transformer 140 then stores the data in a data store local to the content transformer 140, as represented by the flow diagram box numbered 650. The content transformer 140 keeps track of how the data corresponds to the data entry fields.

The content transformer 140 next determines whether the user action comprised the user selecting a “cycle page” button or whether the user action comprised the user selecting the “submit” button. This is represented by the flow diagram decision box numbered 655. If the user action comprised the user selecting a “cycle page” button, then a “cycle” output results in the decision box 655 and the process proceeds to the operation shown in the flow diagram box 630, where the content transformer 140 transmits the requested subdocument to the user device. For example, if the user was viewing the subdocument 217b (FIG. 2) and the user pressed the “next” button 525, the content transformer 140 then transmits the next subdocument in the series (subdocument 217c) to the user device 100. Likewise, execution of the “back” button 530 results in transmittal of the previous subdocument in the series (subdocument 517a).

Prior to transmitting the subdocument, the content transformer 140 preferably determines whether the user had previously provided data for the data entry fields of the requested subdocument. If data has been provided, then the content transformer 140 accesses the data from the local data store and preferably fills the data fields on the subdocument with the appropriate data prior to transmitting the requested subdocument to the user device 100. In this way, the user will not be required to re-enter the data into the data entry fields of the subdocument.

With reference again to the decision box numbered 655, if the user had selected the “submit” button on a subdocument, then the content transformer 140 proceeds to the operation shown in the flow diagram box numbered 665. The content transformer 140 retrieves from the data store all of the data that was received for the data entry fields of the subdocuments. The data had been previously stored in the data store on a subdocument-by-subdocument basis as the user selected the cycle buttons. The content transformer 140 then fills the data entry fields of the original Web form document with the appropriate data and transmits the Web form document and corresponding data to the Web server 125, as represented by the flow diagram box numbered 670. The Web server 125 thereby receives the data without any indication that the content transformer 140 had transformed the original Web form document.

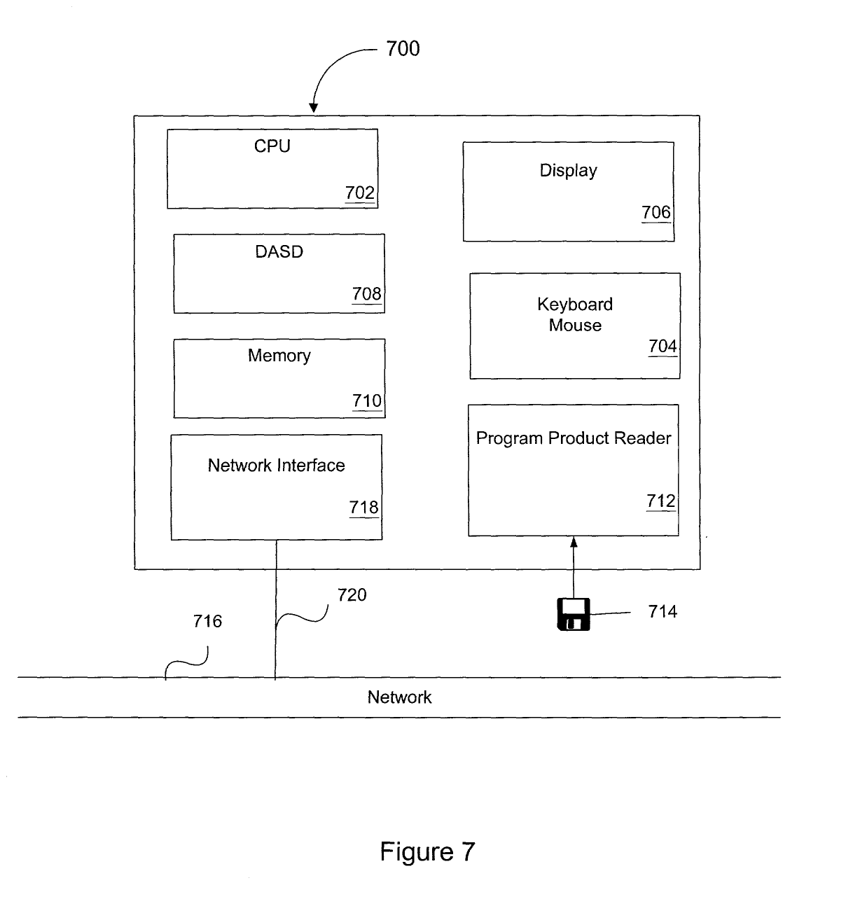

FIG. 7 is a block diagram of an exemplary computer 700 such as might comprise any of the nodes of the computer network 130, including the gateway device 110 or the content server 125. The computer 700 operates under control of a central processor unit (CPU) 702, such as a “Pentium” microprocessor and associated integrated circuit chips, available from Intel Corporation of Santa Clara, Calif., USA. A computer user can input commands and data from a keyboard and computer mouse 704, and can view inputs and computer output at a display 706. The display is typically a video monitor or flat panel display. The computer 700 also includes a direct access storage device (DASD) 708, such as a hard disk drive. The memory 710 typically comprises volatile semiconductor random access memory (RAM).

The computer preferably includes a program product reader 712 that accepts a program product storage device 714, from which the program product reader can read data (and to which it can optionally write data). The program product reader can comprise, for example, a disk drive, and the program product storage device can comprise removable storage media such as a magnetic floppy disk, a CD-R disc, a CD-RW disc, or DVD disc.

The computer 700 can communicate over a computer network 716 (such as the Internet or an intranet) through a network interface 718 that enables communication over a connection 720 between the network 716 and the computer. The network interface 718 typically comprises, for example, a Network Interface Card (NIC) that permits communications over a variety of networks.

The CPU 702 operates under control of programming steps that are temporarily stored in the memory 710 of the computer 700. When the programming steps are executed, the computer performs its functions. Thus, the programming steps implement the functionality of the content transformer 140. The programming steps can be received from the DASD 708, through the program product storage device 714, or through the network connection 720. The program product storage drive 712 can receive a program product 714, read programming steps recorded thereon, and transfer the programming steps into the memory 710 for execution by the CPU 702. As noted above, the program product storage device can comprise any one of multiple removable media having recorded computer-readable instructions, including magnetic floppy disks and CD-ROM storage discs. Other suitable program product storage devices can include magnetic tape and semiconductor memory chips. In this way, the processing steps necessary for operation in accordance with the invention can be embodied on a program product.

Alternatively, the program steps can be received into the operating memory 710 over the network 716. In the network method, the computer receives data including program steps into the memory 710 through the network interface 718 after network communication has been established over the network connection 720 by well-known methods that will be understood by those skilled in the art without further explanation. The program steps are then executed by the CPU. Any of the nodes of the computer network can have an alternative construction, so long as it can support the functionality described herein. For example, the user device 100 may comprise a mobile device that has an antenna and at least some of the components of the computer 700.

The present invention has been described above in terms of a presently preferred embodiment so that an understanding of the present invention can be conveyed. There are, however, many configurations for the system and method not specifically described herein but with which the present invention is applicable. The present invention should therefore not be seen as limited to the particular embodiment described herein, but rather, it should be understood that the present invention has wide applicability with respect to computer network systems generally. All modifications, variations, or equivalent arrangements and implementations that are within the scope of the attached claims should therefore be considered within the scope of the invention.

What is claimed:

1. A method of processing a Web document for display on a user device that is communicatively linked to a computer network, the method comprising:
receiving a copy of the Web document, wherein the Web document includes one or more data entry fields for receiving data;
dividing the Web document into a series of two or more subdocuments, wherein the subdocuments collectively include the data entry fields from the Web document; and
sending a first subdocument in the series of subdocuments to the user device, the first subdocument including one or more data entry fields from the Web document.

2. A method as defined in claim 1, additionally comprising:
receiving a request from the user device for a second subdocument in the series of subdocuments;
receiving a first data set comprised of data from the data entry fields in the first subdocument;
storing the first data set in a data store;
sending the second subdocument to the user device, the second subdocument including one or more data entry fields from the Web document;
receiving a data submission request from the user device, the data submission request including a second data set comprised of data from the data fields in the second subdocument;
retrieving the first data set from the data store; and
sending the first data set and the second data set to a node of the computer network.

3. A method as defined in claim 1, wherein the Web document is written in a markup language.

4. A method as defined in claim 3, wherein the markup language comprises HyperText Markup Language (HTML).

5. A method as defined in claim 3, further comprising:
reviewing one or more tags in the Web document to determine whether the Web document is a Web form document.

6. A method as defined in claim 1, further comprising:
receiving data that describes the capabilities of the user device;
considering the capabilities of the user device when dividing the Web document into a series of two or more subdocuments.

7. A method as defined in claim 6, wherein receiving data that describes the user device comprises receiving information descriptive of the size of the display screen of the user device.

8. A method as defined in claim 7, wherein the subdocuments are each sized to fit within the display screen of the user device.

9. A method as defined in claim 1, wherein the one or more data entry fields for receiving data include a field for receiving textual data.

10. A method as defined in claim 1, wherein the one or more data entry fields for receiving data include a drop-down menu.

11. A method of transforming a Web document for display on a user device that is communicatively linked to a computer network, the method comprising:
receiving a copy of the Web document from a server, wherein the Web document includes one or more data entry fields for receiving data from a user;
dividing the Web document into a series of subdocuments;
sending a first subdocument to the user device for display on the user device, the first subdocument including a first subset of data entry fields from the Web document;
receiving a first set of data from the user device, the first set of data being associated with the data entry fields that were included on the first subdocument;
storing the first set of data in a data store;
transmitting a second subdocument to the user device, the second subdocument including a second subset of data entry fields from the Web document;
re-sending the first subdocument to the user device, wherein the first set of data is inserted into the first subset of data fields.

12. A method as defined in claim 11, additionally comprising:
receiving an instruction from the user device to submit data to a server;
transmitting the first set of data to the server.

13. A method as defined in claim 11, additionally comprising:
receiving a request from the user device for a subdocument from the series of subdocuments;
determining whether any stored data is associated with the data entry fields in the requested subdocument;
if any stored data is associated with the data entry fields in the requested subdocument, then sending the requested subdocument to the user device including the data that is associated with the data entry fields in the requested subdocument.

14. A method as defined in claim 11, wherein the series of subdocuments collectively include all of the data entry fields from the Web document.

15. A method as defined in claim 11, wherein the Web document is written in a markup language.

16. A method as defined in claim 15, wherein the markup language comprises the HyperText Markup Language.

17. A method as defined in claim 15, wherein the subdocuments are written in a markup language that is different from the markup language of the Web document.

18. A method as defined in claim 11, wherein the subdocuments are each sized to fit within a display screen of the user device.

19. A system that transforms a Web document located on a computer network, the system comprising:
content processor means for executing program instructions and receiving a data set; and
a network interface that permits communications between the content processor means and the computer network;
wherein the program instructions executed by the content processor means comprises
receiving a copy of the Web document, wherein the Web document includes one or data entry fields for receiving data,
dividing the Web document into a series of two or more subdocuments, wherein the subdocuments collectively include the data entry fields from the Web document, and
sending a first subdocument in the series of subdocuments to the user device, the first subdocument including one or more data entry fields from the Web document.

20. A system as defined in claim 19, wherein the program instructions executed by the content processor means comprise operations of:
receiving a request from the user device for a second subdocument in the series of subdocuments;
receiving a first data set comprised of data from the data entry fields in the first subdocument;
storing the first data set in a data store;
sending the second subdocument to the user device, the second subdocument including one or more data entry fields from the Web document;
receiving a data submission request from the user device, the data submission request including a second data set comprised of data from the data fields in the second subdocument;
retrieving the first data set from the data store; and
sending the first data set and the second data set to a node of the computer network.

21. A system that transforms a Web document located on a computer network, the system comprising one or more processors that execute program instructions and receive a data set, and:
receive a copy of the Web document from a server, wherein the Web document includes one or more data entry fields for receiving data from a user;
divide the Web document into a series of subdocuments;
send a first subdocument to the user device for display on the user device, the first subdocument including a first subset of data entry fields from the Web document;
receive a first set of data from the user device, the first set of data being associated with the data entry fields that were included on the first subdocument;
store the first set of data in a data store;
transmit a second subdocument to the user device, the second subdocument including a second subset of data entry fields from the Web document; and
re-send the first subdocument to the user device, wherein the first set of data is inserted into the first subset of data fields.

22. A program product for use in a computer system that executes program steps recorded in a computer-readable media to perform a method for transforming a Web document, the program product comprising:
a recordable media;
a program of computer-readable instructions executable by the computer system to perform operations comprising:
receiving a copy of the Web document, wherein the Web document includes one or data entry fields for receiving data;
dividing the Web document into a series of two or more subdocuments, wherein the subdocuments collectively include the data entry fields from the Web document; and
sending a first subdocument in the series of subdocuments to the user device, the first subdocument including one or more data entry fields from the Web document.

23. A program product as defined in claim 22, wherein program of computer-readable instructions executable by the computer system to perform operations further comprising:
receiving a request from the user device for a second subdocument in the series of subdocuments;
receiving a first data set comprised of data from the data entry fields in the first subdocument;
storing the first data set in a data store;
sending the second subdocument to the user device, the second subdocument including one or more data entry fields from the Web document;
receiving a data submission request from the user device, the data submission request including a second data set comprised of data from the data fields in the second subdocument;
retrieving the first data set from the data store; and
sending the first data set and the second data set to a node of the computer network.

24. A program product for use in a computer system that executes program steps recorded in a computer-readable media to perform a method for transforming a Web document, the program product comprising:
a recordable media;
a program of computer-readable instructions executable by the computer system to perform operations comprising:
receiving a copy of the Web document from a server, wherein the Web document includes one or more data entry fields for receiving data from a user;
dividing the Web document into a series of subdocuments;
sending a first subdocument to the user device for display on the user device, the first subdocument including a first subset of data entry fields from the Web document;
receiving a first set of data from the user device, the first set of data being associated with the data entry fields that were included on the first subdocument;
storing the first set of data in a data store;
transmitting a second subdocument to the user device, the second subdocument including a second subset of data entry fields from the Web document;
re-sending the first subdocument to the user device, wherein the first set of data is inserted into the first subset of data fields.

25. A program product as defined in claim 24, wherein program of computer-readable instructions executable by the computer system to perform operations further comprising:
receiving a request from the user device for a subdocument from the series of subdocuments;
determining whether any stored data is associated with the data entry fields in the requested subdocument;
if any stored data is associated with the data entry fields in the requested subdocument, then sending the requested subdocument to the user device including the data that is associated with the data entry fields in the requested subdocument.
